(19) United States
(12) Patent Application Publication
(10) Pub. No.: US 2005/0016820 A1
(43) Pub. Date: Jan. 27, 2005

(54) Worm conveyor for transporting material to be conveyed while hanging on hangers

(76) Inventor: Rolf Peter Beyer, Buchloe (DE)

Correspondence Address: ROTHWELL, FIGG, ERNST & MANBECK, P.C., 1425 K STREET, N.W., SUITE 800, WASHINGTON, DC, 20005, US

(21) Appl. No.: 10/499,193

(22) PCT Filed: Dec. 19, 2002
(86) PCT No.: PCT/EP02/14601

(30) Foreign Application Priority Data
Dec. 21, 2001 (DE) 101 63 427.7

(51) Int. Cl. B65G 47/61; B65G 33/02

(52) U.S. Cl. 198/662; 198/676

(57) ABSTRACT

A screw conveyor for transporting goods to be conveyed while hanging on hangers (10), in particular items of clothing hanging on clothes hangers, comprises a screw shaft strand (20) which is rotatably mounted about its shaft axis (22) and on whose outer surface a conveyor thread system (24) that winds in the manner of a screw around the shaft axis is formed. The hangers can be hooked into the conveyor thread system with upper hanger hooks (18) and can be conveyed axially therein in a conveying direction (14) as a result of rotation of the screw shaft strand. At least one separating region (52) used for separating the hangers (10) and having an individual conveyor groove (68) formed for the individually conveyance of the hangers is formed along the screw shaft strand. According to the invention, the conveyor thread system for directing the hangers into the individual conveyor groove forms a directing conveyor thread (70) for the hangers which tapers in the manner of a funnel along the turns direction of the conveyor thread system and which, at least on part of its length running in the turns direction, at its front edge relative to the conveying direction, adjoins the individual conveyor groove in a substantially rib-free manner. If a plurality of hangers (10-1, 10-2, 10-3) run into the directing conveyor thread, then the leading one (10-1) of these hangers in the conveying direction is directed into the individual conveying groove as the screw shaft strand rotates. The hangers are supplied continuously and without gaps to a conveyor thread system.

The invention relates to a screw conveyor for transporting goods to be conveyed while hanging on hangers, in particular items of clothing hanging on clothes hangers.

Screw conveyors are used, for example, for transporting items of clothing hanging on clothes hangers, for example within the context of a suspended conveyor system for sorting and picking items of clothing for orders. In the screw conveyor, the clothes hangers are hooked with their upper hanger hooks in a screw thread which is formed on the outer surface of a screw shaft. If the screw shaft is driven in rotation about its shaft axis, then the clothes hangers accommodated in the screw thread are moved onward in the direction of the shaft axis. In order to fulfill various tasks, the screw thread can branch along the screw shaft, it can combine with another screw thread, new screw threads and the like can be produced, for which reason here, mention is made generally of a screw or conveyor thread system formed on the outer surface of the screw shaft.

One of the tasks which have to be fulfilled on the clothes hangers during their passage through the screw conveyor is generally the separation of the clothes hangers. It often occurs that a plurality of clothes hangers get into one turn of a conveyor thread at the same time. In order to be able to discharge the clothes hangers individually at the discharge end of the screw conveyor, it is necessary to separate the clothes hangers, so there is no more than one hanger in one thread turn. For this purpose, it is known to provide a separating region along the screw shaft, having an individual conveyor groove formed for the individual conveyance of the hangers. The groove turns of the individual conveyor groove are led close to one another and then drawn apart again. In conjunction with the groove cross section of the individual conveyor groove, coordinated in terms of size to accommodate only one clothes hanger, effective separation of the clothes hangers is made possible in this way.

In order to achieve the maximum conveying capacity of the screw conveyor, each groove turn of the individual conveyor groove should always be occupied by one clothes hanger, so that no unoccupied, empty groove turns occur. The continuous occupancy of the groove turns of the individual conveyor groove has frequently proven to be problematic in the case of previous screw conveyors, however. This leads to gaps in the transport flow of the clothes hangers and signifies a correspondingly reduced conveyed quantity which can be passed through the screw conveyor in a given time.

It is therefore an object of the invention to improve the conveying capacity of a screw conveyor having at least one separating region.

In achieving this object, the invention starts from a screw conveyor for transporting goods to be conveyed while hanging on hangers, in particular items of clothing hanging on clothes hangers, comprising a screw shaft strand rotatably mounted about its shaft axis and having a conveyor thread system which is formed on the outer surface of the screw shaft strand and winds in the manner of a screw around the shaft axis, into which the hangers can be hooked with upper hanger hooks and can be conveyed axially therein in a conveying direction as a result of rotation of the screw shaft strand, at least one separating region used for separating the hangers and having an individual conveyor groove formed for the individual conveyance of the hangers being formed along the screw shaft strand.

In this case, the invention provides for the conveyor thread system for directing the hangers into the individual conveyor groove to form a directing conveyor thread for the hangers which tapers in the manner of a funnel along the turns direction of the conveyor thread system and which, at least on part of its length running in the turns direction, at its front edge relative to the conveying direction, adjoins the individual conveyor groove in a substantially rib-free manner, in such a way that, of a plurality of hangers that have run into the directing conveyor thread, the leading one of these hangers in the conveying direction runs into the individual conveyor groove as the screw shaft strand rotates.

In the solution according to the invention, the taper of the directing conveyor thread achieves a funnel effect, so to speak: the hanger hooks of the hangers that have run into the directing conveyor thread are compacted, gaps between them are closed or at least reduced. By means of this bundling of the hanger hooks, it is ensured that one hanger hook is always ready to be directed into the individual conveyor groove, since the bundling of the hanger hooks specifically has the effect that the hanger hook of the leading hanger has a pressure forward, that is to say in the conveying direction, exerted on it by the following hangers, which permits the leading hanger to run reliably into the individual conveyor groove. In this way, the screw conveyor can be fully utilized and a maximum quantity to be conveyed can be transported by the screw conveyor. In addition, individually conveyed hangers run reliably into the individual conveyor groove.

If mention is made here of a screw shaft strand, then this is understood to mean both a continuously coherent individual shaft, which can be produced in one piece or built up from a plurality of shaft pieces which are separate but firmly connected to one another so as to rotate with one another, and also a segmented shaft strand having a plurality of shaft segments which are arranged coaxially one after another and can rotate relative to one another. Such shaft segments which can rotate relative to one another permit different sections of the screw shaft strand to be driven at different rotational speeds as required.

In order to make it easier to direct the leading hanger into the individual conveyor groove, the screw shaft strand, at least on part of the length of the directing conveyor thread, can have a shaft radius which increases from the front edge of the directing conveyor thread in the direction of its rear edge, so that the hangers in the directing conveyor thread can, so to speak, slide on a falling section toward the front edge of the directing conveyor thread.

In a preferred embodiment, the directing conveyor thread extends in between two adjacent groove turns of the individual conveyor groove in such a way that, of a plurality of hangers that have run into the directing conveyor thread, the leading one of these hangers in the conveying direction runs into the front groove turn of the individual conveyor groove as the screw shaft strand rotates, and the immediately following hanger runs into the rear groove turn of the individual conveyor groove. For situations in which more than two hangers can run simultaneously into the directing conveyor thread, it is recommended that the directing conveyor thread be configured in such a way that, in the event that three or more hangers run into the directing conveyor thread as the screw shaft strand rotates, the third following and, if appropriate, each following hanger in the conveying direction is thrown back from a front thread turn of the directing conveyor thread into an immediately following thread turn of the directing conveyor thread.

In the separating region, the individual conveyor groove preferably has successive groove turns whose pitch is approximately equal to or somewhat smaller than the material thickness of the hanger hooks in the region of their engagement in the individual conveyor groove. In order to increase the conveying capacity, a further individual conveyor groove can arise in this case in the separating region, between two closely successive groove turns of the individual conveyor groove.

In some cases it may be sufficient if there is only a single separating region along the screw shaft strand. Often, however, even after initial separation of the hangers, a further requirement for separation must be expected, for example because, in the context of the initial separation, not all the hangers could be directed into their own turn in the conveyor thread system or because, in the context of tasks carried out subsequently on the hangers, renewed accumulation of two or more hangers in one thread turn can occur. It is therefore proposed to form at least two separating regions with mutual axial spacing along the screw shaft strand.

A separating region will expediently follow a tailback conveying region of the screw conveyor in the conveying direction, in which region the screw shaft strand is constructed so as to be capable of causing a tailback. This makes it possible to release the hangers which have tailed back individually from the tailback and to supply them individually to subsequent tasks. In particular, the tailback conveyor region can be a secondary tailback conveyor region, which can be charged with hangers via an intermediate conveyor section from an upstream primary tailback conveyor region of the screw conveyor, a controllable stop being assigned to the primary tailback conveyor region, by means of which stop the hangers can be caused to tail back in the primary tailback conveyor region.

In this case, the secondary tailback conveyor region can be assigned a tailback detector which, when a predetermined tailback length is reached in the secondary tailback conveyor region, provides a feedback signal. An electronic control unit of the screw conveyor, connected to the tailback detector, can then control the switching state of the stop as a function of the feedback signal, so that a certain quantity of hangers under slight tailback pressure can always be present in the separating region. It has been shown that such a design makes it possible to manage with a single stop along the screw shaft strand.

However, a separating region can also follow an untangling region of the screw conveyor in the conveying direction, in which the conveyor thread system is designed to untangle crossed hangers. This is because, during the mechanical untangling of crossed hangers, it is possible for two or more hangers to leave the untangling region in a common thread turn of the conveyor thread system, and therefore there is a need for separation. In order to be able to eliminate any remaining crossovers between hangers, a crossover detection region of the screw conveyor, which is designed for the detection of crossed over hangers by sensors, can follow the separating region in the conveying direction.

An exemplary embodiment of the invention will be explained in more detail below using the appended drawings, in which:

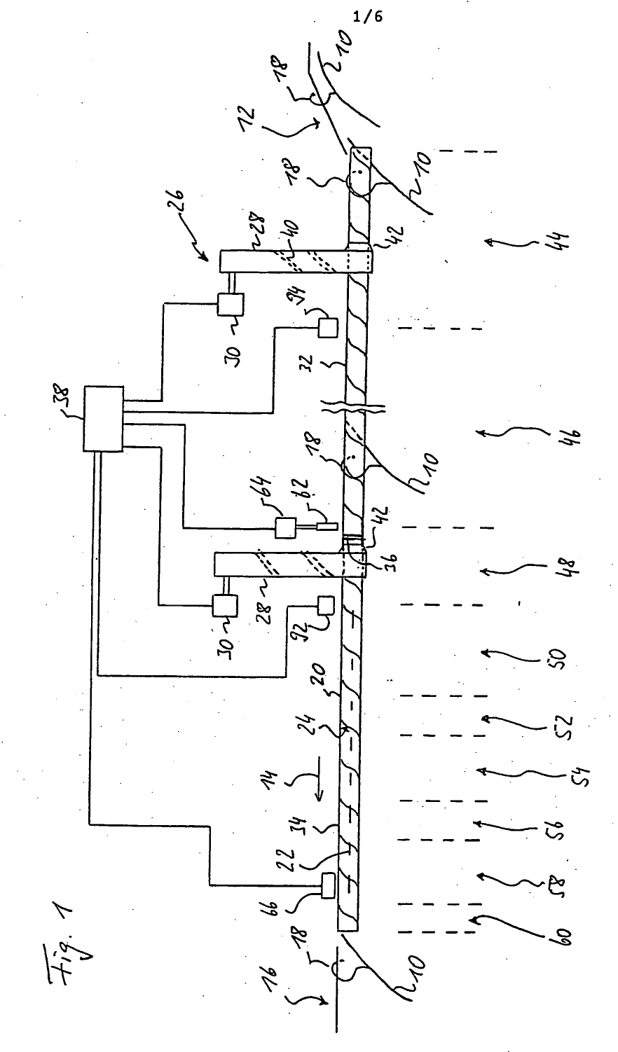

FIG. 1 shows, highly schematically, an overview of a screw conveyor according to the invention, and

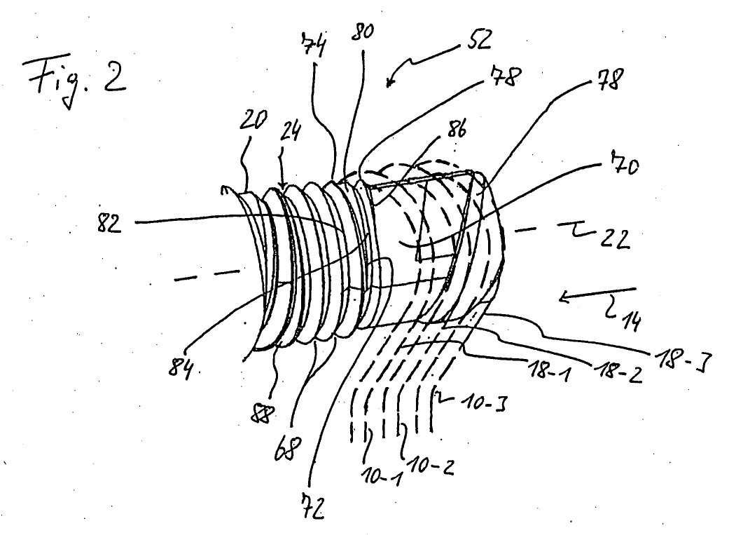

FIGS. 2-6 show, in an enlarged perspective, various rotary positions of a shaft section of a screw shaft strand of the screw conveyor of FIG. 1 in order to explain a gap closing and separating process which is performed on clothes hangers which are transported by the screw conveyor.

The screw conveyor shown in FIG. 1 is used for transporting hangers 10 which are supplied by an upstream transport system 12 and are transferred to the screw conveyor. After they have run through the screw conveyor along a conveying direction 14, the hangers 10 are discharged to a downstream transport system 16, which transports the hangers 10 away to their further use. The hangers 10 in the present example are clothes hangers, which in each case have an upper hanger hook 18 and on which items of clothing, not specifically illustrated, are hung. It goes without saying that the screw conveyor can in principle also be used for the transport of any other desired hangers instead of such clothes hangers. The transport system 12 supplying the clothes hangers 10 can, for example, be a pawl conveyor, while the transport system 16 transporting the clothes hangers 10 away can be, for example, a suspended conveyor device with individual hangers that can be moved on rollers. In order to transport the clothes hangers 10 in and away, transport systems other than the aforementioned can of course also be used, for example a suspended conveyor device with multiple hangers that can be moved on rollers, which are often designated trolleys and have a loadbearing rail on which a plurality of clothes hangers 10 can be suspended.

The screw conveyor has a screw shaft strand 20 which is arranged with its shaft axis 22 parallel to the conveying direction 14 and is mounted on a loadbearing construction, not specifically illustrated, such that it can rotate about this axis 22. On the outer surface of the screw shaft strand 20, a conveyor thread system 24 winding in the manner of a screw about the shaft axis 22 is machined along the latter, in which the clothes hangers 10 can be hung by their hanger hooks 18. If the screw shaft strand 20 is set rotating about its shaft axis 22, then the clothes hangers 10 hanging thereon are moved onward in the axial direction. In the schematic drawing of FIG. 1, the conveyor thread system 24 is illustrated as though it were to have only a single conveyor or screw thread which extends with constant pitch over the entire length of the screw shaft strand 20. However, this mode of illustration is used merely for simplification; it goes without saying that, at least in some sections, the conveyor thread system 24 can have a plurality of screw threads running beside one another and that the pitch of each screw thread can be variable along the shaft axis 22. In particular, along the screw shaft strand 20 there can be branching or combining points, at which a screw thread branches or two screw threads run together. By means of variation of the thread pitch and/or the numbers of screw threads, various tasks which are to be performed on the clothes hangers 10 can be fulfilled as they run through the screw conveyor.

A rotary drive device designated generally by 26 is used for the rotary drive of the screw shaft strand 20. This rotary drive device 26 has at least one flexible drive belt 28 which is preferably arranged with an axial spacing from the longitudinal ends of the screw shaft strand 20, wraps around the screw shaft strand 20 over part of the circumference of its outer surface so as to transmit driving force, for example by means of interengaging tooth systems, and can be driven to circulate in an endless loop by means of an electric motor drive 30. In the present example of FIG. 1, two such drive belts 28 are show. The two drive belts are arranged with an axial spacing from each other and, independently of each other, in each case drive one of two mutually coaxial strand segments 32, 34 of the screw shaft strand 20, which are separated from each other at a separating point 36 and can be rotated about the shaft axis 22 independently of each other. An electronic control unit 38 controlling the operation of the screw conveyor permits mutually independent, in particular variable rotational speed, control of the drives 30.

On their way through the screw conveyor, the clothes hangers 10 run over the drive belts 28. In order to ensure that they are guided reliably over the drive belts 28, on their side on the outside of the loop the drive belts 28 have an arrangement of mutually parallel conveyor grooves, which extend over the entire width of the respective drive belt 28 and run at an angle to its circumferential direction. Two such conveyor grooves are shown dashed in FIG. 1 in the right-hand drive belt 28 and are designated by 40 there. The conveyor grooves are configured and aligned with respect to the conveyor thread system 24 of the screw shaft strand 20 in such a way that clothes hangers 10 which approach one of the drive belts 28 can run out of the conveyor thread system 24 directly into one of the conveyor grooves and, after traversing the relevant drive belt 28, can be threaded into the conveyor thread system 24 of the screw shaft strand 20 again without disruption. In order to compensate for any differences in diameter, an adapter ring 42 can be arranged at least on the feed side of each drive belt 28.

In a preferred form of use of the screw conveyor, clothes hangers 10 can be put onto the screw conveyor in disordered heaps, the screw conveyor being given the task of conveying the clothes hangers 10, separating them, disentangling them, cycling and counting them, so that they leave the screw conveyor individually one after another. In order to fulfill these tasks, the screw shaft strand 20 is subdivided functionally into various regions. From the right-hand longitudinal end of the screw shaft strand 20 in FIG. 1, these are successively: an acceptance region 44, a large tailback region 46, a conveyor region 48, a small tailback region 50, a first separating region 52, an untangling region 54, a second separating region 56, a crossover detection region 58 and a transfer region 60. In order to illustrate the position of these regions along the screw shaft strand 20, they are delimited from one another in FIG. 1 by dashed lines. It goes without saying that such a sharp delimitation is used only to simplify the illustration and, in practice, there can be smooth transitions between the various functional regions of the screw shaft strand 20.

In the acceptance region 44, the clothes hangers 10 are accepted from the transport system 12 and are transported in the conveying direction 14 to the tailback region 46. The leading end of the tailback region 46 is defined by a stop 62 which, by means of an actuator 64, for example an electromagnetic actuator, can be switched between a stop position, in which it causes the incoming clothes hangers 10 to tail back, and a release position, in which the clothes hangers 10 can run past it. In the tailback region 46, the screw shaft strand 20 is constructed as what is known as a tailback conveyor, that is to say the clothes hangers 10 are conveyed onward in the conveying direction 14 as long as they do not encounter any resistance. However, if they meet the stop 62 or a clothes hanger tailed back in front of them, they remain at a standstill.

Via the conveying region 48, the clothes hangers 10 then reach the tailback region 50, in which the shaft screw strand 20 is in turn constructed to be capable of forming a tailback. The tailback in the tailback region 50 is not formed by a controllable stop but is effected by the separating region 52, in front of which the clothes hangers 10 can tail back if they are supplied in a number which exceeds the throughput capacity of the separating region 52.

In the separating region 52, any clothes hangers 10 which have crossed over are detected, so that these can be guided jointly into the untangling region 54, where untangling, that is to say uncrossing, of clothes hangers 10 which have crossed over is effected merely by suitable configuration of the conveyor thread system 24. Such untangling regions are known per se in screw conveyors, for which reason a more detailed explanation will be omitted. Following renewed separation in the separating region 56, the clothes hangers 10 are examined in the crossover detection region 58 for any remaining crossovers between clothes hangers 10. In order to detect such a crossover state, use is made of sensors 66 connected to the control unit 38. If the control unit 38 establishes, by using the signals from the sensors 66, that clothes hangers 10 which have crossed over are present in the crossover detection region 58, then it stops the conveyor and arranges for a warning notification to be output, in order that an operator can uncross or remove the clothes hangers 10 which have crossed over. In the transfer region 60, the clothes hangers 10 are finally transferred to the transport system 16.

In order to explain the construction and action of the separating regions 52, 56, reference will now be made to FIGS. 2-6. The separating regions 52, 56 are substantially identically constructed, so that it is sufficient to explain one of the separating regions 52, 56. In FIGS. 2-6, this is the separating region 52.

In the separating region 52, the conveyor thread system 24 has an individual conveyor groove 68, designated a separating groove below, whose approximately V-shaped cross section is dimensioned such that, for each turn, only one hanger hook 18 can be accommodated in the separating groove 68. In the central part of the separating region 52, the turns of the separating groove 68 are closely adjacent to one another; the groove pitch corresponds approximately to the material thickness of the hanger hooks 18 or is even somewhat smaller. In an entry part preceding the central part of the separating region 52, the pitch of the separating groove 68 is greater than in the central part and decreases gradually in the direction of the turns to the value in the central part. In an exit part following the central part, the pitch of the separating groove 68 increases again; the turns of the separating groove 68 are accordingly distanced from one another again.

In the entry part of the separating region 52, the conveyor thread system 24 forms a directing conveyor thread 70, which will be called the gap closing thread in the following text, which is fed with clothes hangers 10 from the preceding functional region of the screw conveyor, the tailback region 50 here. The gap closing thread 70 winds around the axis 22, preferably by more than one turn, and tapers in the direction of the turns in the manner of a funnel, until it ends finally in a tapering end 72 running to a point. It forms a conveying path which is flat in the conveying direction 14 for the clothes hangers 10, whose radial level lies above the bottom of the separating groove 68. In a directing region, which extends over part of the length of the gap closing thread 70 running in the direction of the turns, the separating groove 68 adjoins the front edge of the gap closing thread 70, seen in the conveying direction, in a rib-free manner. A clothes hanger 10 conveyed to the front edge of the gap closing thread 70 can therefore fall directly from the gap closing thread 70 into the separating groove 68 in the directing region, without encountering a radial elevation between the conveying path of the gap closing thread 70 and the separating groove 68 in the process and having to overcome said elevation.

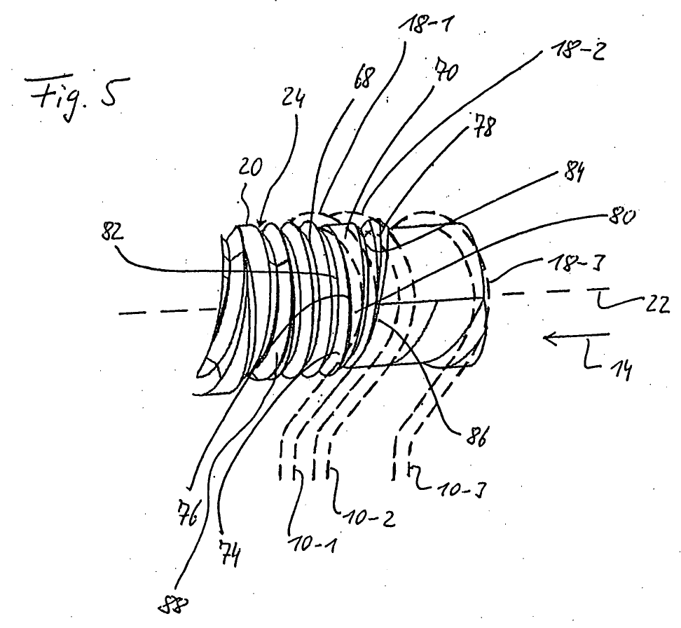

In relation to the direction of the turns following the directing region, but before the tapering end 72 of the gap closing thread 70, a dividing rib 74 arises at the front edge of the gap closing thread 70, is elevated above the radial level of the conveying path of the gap closing thread 70 and divides the separating groove 68 from the gap closing thread 70. This dividing rib 74 has the effect that clothes hangers 10, as soon as they have run into the separating groove 68 over the leading edge of the gap closing thread 70, are held in the separating groove 68 and are transported onward therein. The approximate location at which the dividing rib 74 arises can be seen easily at 76 in FIG. 5. After the tapering end 72 of the gap closing thread 70, in the direction of the turns, the dividing rib 74 in the central part of the separating region 52 forms an immediate division between the successive turns of the separating groove 68.

After the gap closing thread 70, in relation to the conveying direction 14, at least over a substantial part of the length of the gap closing thread 70, a forward drive and compaction rib 78 running obliquely with respect to the circumferential direction of the screw shaft strand 20 is elevated above the radial level of the conveying path of the gap closing thread 70. As the screw thread strand 20 rotates, the forward drive and compaction rib 78 has the effect of an axial forward drive of the clothes hangers 10 which have run into the gap closing thread 70 in the direction of the front edge of the gap closing thread 70. Since, with increasing rotational angle of the screw shaft strand 20, the axial width of the gap closing thread 70 becomes smaller, compaction of the hanger hooks 18 of these clothes hangers 10 is carried out at the same time. The forward drive and compaction rib 78 is configured in such a way that, at the start, when the axial width of the gap closing thread 70 is still comparatively large and the compaction pressure is correspondingly low, the forward drive and compaction rib 78 can hold the clothes hangers 10 in the gap closing thread 70. However, beginning from a certain narrowing of the gap closing thread 70, the compaction pressure becomes so high that a rear proportion of the clothes hangers 10 that have run into the gap closing thread 70 are thrown back rearward over the forward drive and compaction rib 78 into a previous turn of the gap closing thread 70.

Finally, it can be seen easily in FIG. 2 that, with a thread section 80 which is close to the end and reaches as far as the tapering end 72, the gap closing thread 70 reaches into the space between two adjacent turns 82, 84 of the separating groove 68, which taper toward each other in the direction of the turns. In this thread section 80 close to the end, at the front edge of the gap closing thread 70, the dividing rib 74 has already arisen, but the rear edge of the gap closing thread 70 merges in a rib-free manner into the rear of the two adjacent groove turns of the separating groove 68 which have been mentioned, that is to say into the groove turn 84 here. The forward drive and compaction rib 78 extends along the gap closing thread 70 until approximately in the region of the thread section 80 close to the end of the gap closing thread 70 and then flattens until it disappears completely. The approximate location at which the forward drive and compaction rib 78 disappears can be seen in FIG. 2 at 86. As a result of the flattening of the forward drive and compaction rib 78, the rib-free transition between the front edge of the gap closing thread 70 and the separating groove 68 is created in the directing region of the gap closing thread 70.

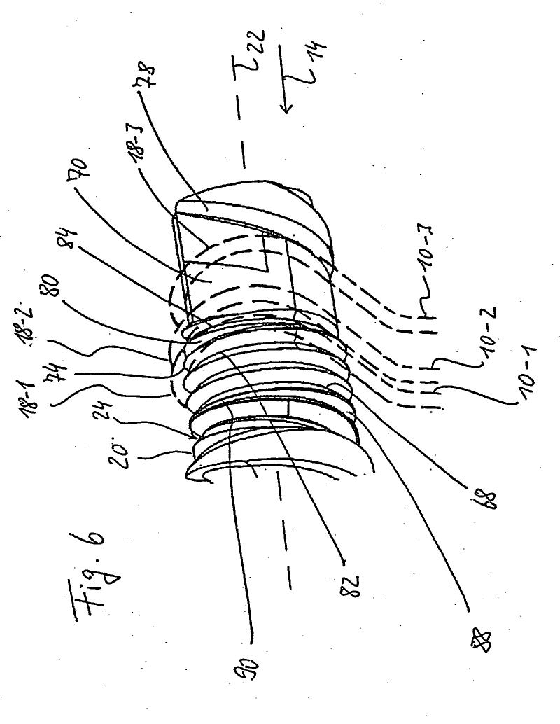

By using FIGS. 2-6, the action of the separating region 52 configured in the above manner will be explained for an example in which three clothes hangers 10 run simultaneously into the gap closing thread 70. From figure to figure, the screw shaft strand 20 is rotated onward by 90° in each case, so that FIG. 6 shows the same rotary position of the screw shaft strand 20 as FIG. 2 shows but after a further rotation through 360°.

To be able to distinguish the three clothes hangers better, these are designated by 10-1, 10-2 and 10-3 in FIGS. 2-6; accordingly, their hanger hooks are designated by 18-1, 18-2 and 18-3.

In FIG. 2 the clothes hangers 10-1, 10-2, 10-3 are located in an initial section of the gap closing thread 70, in which the axial width of the gap closing thread 70 is still sufficiently large for no compacting action to be exerted on the hanger hooks 18-1, 18-2, 18-3 of these clothes hangers.

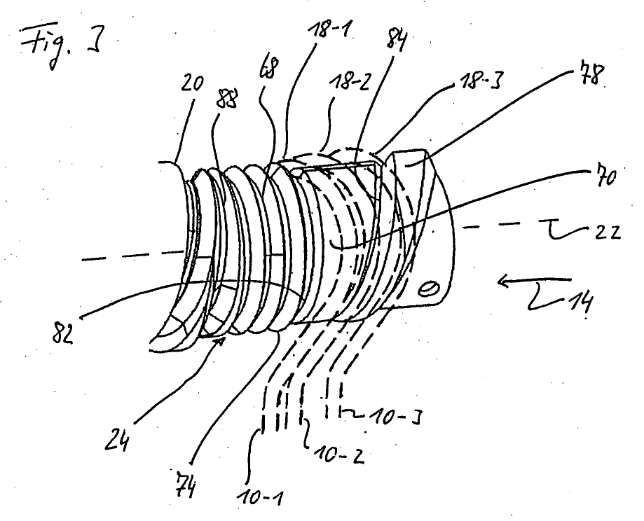

If the screw shaft strand 20 is rotated onward into the rotary position shown in FIG. 3, slow compaction of the hanger hooks 18-1, 18-2, 18-3 begins. This compaction has the effect of a pressure directed forward on the leading hanger hook 18-1 in the conveying direction 14. As a result of this pressure, the hanger hook 18-1 is pushed over the rib-free, front edge of the gap closing thread 70 and falls into the groove turn 82 of the separating groove 68. This state, in which the leading clothes hanger 10-1 is gripped by the separating groove 68, can easily be seen in FIG. 3.

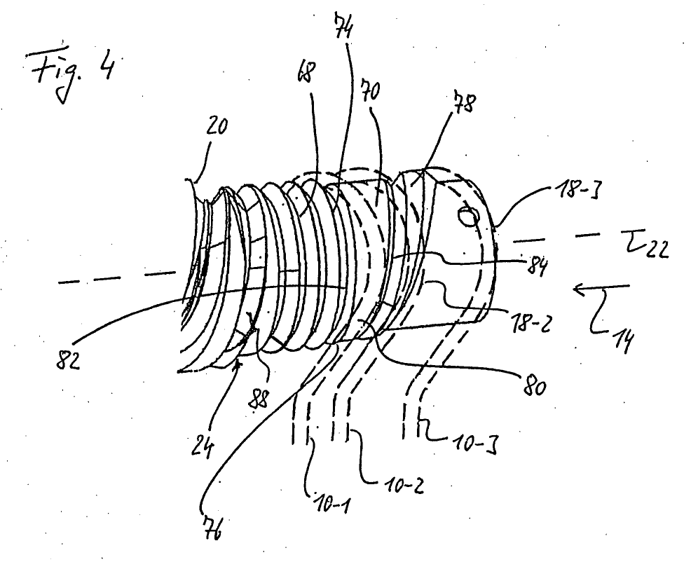

If the screw shaft strand 20 is rotated onward, the gap closing thread 70 narrows still more. The two hanger hooks 18-2 and 18-3 that have remained in the gap closing thread 70 thus experience an increasing compaction pressure which, beginning at a specific intensity, leads to the rear hanger hook 18-3 overcoming the forward drive and compaction rib 78 and being thrown back into the previous turn of the gap closing thread 70. During the next revolution of the screw shaft strand 20, the clothes hanger 10-3 thrown back in this way is then on the tip in front of any further clothes hangers which are fed into the gap closing thread 70 from the tailback region 50. The clothes hanger 10-3 thrown back can be seen easily in FIG. 4.

During onward rotation of the screw shaft strand 20 into the rotary position shown in FIG. 5, the gap closing thread 70 finally becomes so narrow that the hanger hook 18-2 of the central clothes hanger 10-2 is also gripped by the separating groove 68. It slips over the rear end of the conveying path of the gap closing thread 70 into the turn 84 of the separating groove 68. In this way, no gap is produced with respect to the first following clothes hanger 10-1, which is running in the immediately preceding turn 82 of the separating groove 68.

FIG. 6 shows the state following a complete revolution of the screw shaft strand 22. The front clothes hanger 10-1 and the central clothes hanger 10-2 have both been directed into the separating groove 68 and are passing through the latter without any gap, that is to say in successive turns. The rear clothes hanger 10-3 is directed into the turn 82 of the separating groove 68 during the next revolution of the screw shaft strand 20, so that no gap is produced between the central clothes hanger 10-2 and the rear clothes hanger 10-3 either. The following functional regions of the screw shaft strand 20 can thus be charged continuously at the cycle rate with separated clothes hangers 10.

In order to make it easier to direct the front clothes hanger 10-1 into the turn 82 of the separating groove 68, the screw shaft strand 20 is designed over part of the length of the gap closing thread 70 with a shaft radius which decreases slightly axially toward the front edge of the gap closing thread 70. In this way, in the gap closing thread 70 there results a conveying path which declines somewhat from the rear edge to the front edge, which makes it easier to urge the front clothes hanger 10-1 toward the front edge of the gap closing thread 70.

It is not possible to rule out the situation in which, even after passing through the gap closing thread 70, clothes hangers 10 still occur in a heap instead of being conveyed cleanly separated from one another in a groove turn of the separating groove 68 in each case. In order to avoid overrunning the separating groove 68, in the exemplary embodiment of FIGS. 2-6 a further individual conveying groove, which is designated by 88 there, arises between two successive turns of the separating groove 68. The approximate location at which this further individual conveying groove 88 arises is designated 90 in FIG. 6. If excess numbers of clothes hangers 10 occur, which have no space in the turns of the separating groove 68 (that is to say those clothes hangers 10 which exceed the conveying capacity of the separating groove 68), these are located somewhat above the dividing rib 74 between two successive turns of the separating groove 68. If such excessive numbers of clothes hangers 10 then get into the region of the original location 90 of the further individual conveying groove 88, then they inevitably fall into the individual conveying groove 88 and are transported onward in the latter.

Reference will now be made to FIG. 1 again. There, at 92, a tailback detector connected to the control unit 38 is indicated, which sends feedback to the control unit 38 when the clothes hangers 10 in the tailback region 50 tail back to a predetermined location. Depending on the signal from the tailback detector 92, the control unit 38 controls the switching state of the stop 62. This control is carried out in such a way that a certain length of the tailback upstream of the separating region 52 is always maintained. If the tailback length is shorter, the control unit 38 effects temporary opening of the stop 62, so that clothes hangers 10 from the large tailback region 46 can run on into the small tailback region 50. Then, once the tailback length again reaches a predetermined length, the control unit 38 effects the closure of the stop 62. In this way, there is always a certain quantity of clothes hangers 10 under a comparatively low tailback pressure upstream of the separating region 52.

A further tailback detector 94 is used to detect the tailback length in the large tailback region 46. Depending on its feedback signal, the control unit 38 controls the charging of the screw conveyor with clothes hangers 10. Thus, overall, one stop and one tailback detector are sufficient for the operation of the screw conveyor.

1. A screw conveyor for transporting goods to be conveyed while hanging on hangers (10), in particular items of clothing hanging on clothes hangers, comprising a screw shaft strand (20) rotatably mounted about its shaft axis (22) and having a conveyor thread system (24) which is formed on the outer surface of the screw shaft strand (20) and winds in the manner of a screw around the shaft axis (22), into which the hangers (10) can be hooked with upper hanger hooks (18) and can be conveyed axially therein in a conveying direction (14) as a result of rotation of the screw shaft strand (20), at least one separating region (52, 56) used for separating the hangers (10) and having an individual conveyor groove (68) formed for the individual conveyance of the hangers (10) being formed along the screw shaft strand (20), characterized in that the conveyor thread system (24) for directing the hangers (10) into the individual conveyor groove (68) forms a directing conveyor thread (70) for the hangers (10) which tapers in the manner of a funnel along the turns direction of the conveyor thread system (24) and which, at least on part of its length running in the turns direction, at its front edge relative to the conveying direction (14), adjoins the individual conveyor groove (68) in a substantially rib-free manner, in such a way that, of a plurality of hangers (10-1, 10-2, 10-3) that have run into the directing conveyor thread (70), the leading one (10-1) of these hangers (10-1, 10-2, 10-3) in the conveying direction (14) runs into the individual conveyor groove (68) as the screw shaft strand (20) rotates.

2. The screw conveyor as claimed in claim 1, characterized in that the screw shaft strand (20), at least on part of the length of the directing conveyor thread (70), has a shaft radius which increases from the front edge of the directing conveyor thread (70) in the direction of its rear end.

3. The screw conveyor as claimed in claim 1, characterized in that the directing conveyor thread (70) extends in between two adjacent groove turns (82, 84) of the individual conveyor groove (68) in such a way that, of a plurality of hangers (10-1, 10-2, 10-3) that have run into the directing conveyor thread (70), the leading one (10-1) of these hangers (10-1, 10-2, 10-3) in the conveying direction (14) runs into the front groove turn (82) of the individual conveyor groove (68) as the screw shaft strand (20) rotates, and the immediately following hanger (10-2) runs into the rear groove turn (84) of the individual conveyor groove (68).

4. The screw conveyor as claimed in claim 3, characterized in that the directing conveyor thread (70) is configured in such a way that, in the event that three or more hangers (10-1, 10-2, 10-3) run into the directing conveyor thread (70) as the screw shaft strand (20) rotates, the third following (10-3) and, if appropriate, each following hanger in the conveying direction (14) is thrown back from a front thread turn of the directing conveyor thread (70) into an immediately following thread turn of the directing conveyor thread (70).

5. The screw conveyor as claimed in claim 1, characterized in that, in the separating region (52, 56), the individual conveyor groove (68) has successive groove turns whose pitch is approximately equal to or somewhat smaller than the material thickness of the hanger hooks (18) in the region of their engagement in the individual conveyor groove (68).

6. The screw conveyor as claimed in claim 5, characterized in that a further individual conveyor groove (88) arises in the separating region (52, 56), between two closely successive groove turns of the individual conveyor groove (68).

7. The screw conveyor as claimed claim 1, characterized in that at least and preferably a total of two separating regions (52, 56) are formed with mutual axial spacing along the screw shaft strand (20).

8. The screw conveyor as claimed claim 1, characterized in that a separating region (52) follows a tailback conveying region (15) of the screw conveyor in the conveying direction (14), in which region the screw shaft strand (20) is constructed so as to be capable of causing a tailback.

9. The screw conveyor as claimed in claim 8, characterized in that the tailback conveyor region (50) is a secondary tailback conveyor region, which can be charged with hangers (10) via an intermediate conveyor section (48) from an upstream primary tailback conveyor region (46) of the screw conveyor, a controllable stop (62) being assigned to the primary tailback conveyor region (46), by means of which stop the hangers (10) can be caused to tail back in the primary tailback conveyor region (46).

10. The screw conveyor as claimed in claim 9, characterized in that the secondary tailback conveyor region (50) is assigned a tailback detector (92) which, when a predetermined tailback length is reached in the secondary tailback conveyor region (50), provides a feedback signal, and in that an electronic control unit (38) of the screw conveyor, connected to the tailback detector (92), controls the switching state of the stop (62) as a function of the feedback signal.

11. The screw conveyor as claimed in claim 10, characterized in that the stop (62) is the only stop provided along the screw shaft strand (20).

12. The screw conveyor as claimed claim 1, characterized in that a separating region (56) follows an untangling region (54) of the screw conveyor in the conveying direction (14), in which the conveyor thread system (24) is designed to untangle crossed hangers (10).

13. The screw conveyor as claimed in claim 12, characterized in that a crossover detection region (58) of the screw conveyor, which is designed for the detection of crossed over hangers (10) by sensors, follows the separating region (56) in the conveying direction (14).
